(19) United States
(12) Patent Application Publication
(10) Pub. No.: US 2004/0054555 A1
(43) Pub. Date: Mar. 18, 2004

(54) E-commerce multilevel marketing and fraud prevention

(76) Inventors: Gregory A. Piccionelli, Westlake Village, CA (US); Michael M. Gerardi, Menifee, CA (US)

Correspondence Address: Michael M. Gerardi, Esq., 28876 Woodcrest Lake Drive, Menifee, CA, 92584, US

(21) Appl. No.: 10/659,654

(22) Filed: Sep. 10, 2003

Related U.S. Application Data
(60) Provisional application No. 60/410,028, filed on Sep. 12, 2002.

(51) Int. Cl. G06F 17/60

(52) U.S. Cl. 705/1

(57) ABSTRACT

A method of acquiring a membership in a destination site on a network includes the steps of: accessing an affiliate site on a network, the affiliate site including a hyperlink to a destination site; accessing the destination site by activating the hyperlink; and acquiring a membership in the destination site and a tangible good associated with the membership in the destination site.

This application is based on U.S. Provisional Patent Application Serial No. 60/410,028, filed Sep. 12, 2002, the disclosure of which is incorporated in its entirety herein by reference.

### FIELD OF THE INVENTION

The present invention relates to a multilevel marketing method suitable for e-commerce, and to a method that inhibits fraudulent transactions occurring in e-commerce.

### BACKGROUND OF THE INVENTION

E-commerce, and specifically e-commerce in non-tangible goods and services, such as adult entertainment sites, is susceptible to fraud in connection with merchant processing of payment via credit cards or other credit accounts, due precisely to the non-tangible nature of the goods and services. In such transactions, a user purchases, for example, a membership in an adult membership site, a downloaded software upgrade, a music or video, or another product or service that has an electron-only composition, without an associated tangible product that is shipped to the user. Once the user has received the membership, software or other intangible good or service, it is then a simple matter for the user to claim that the he did not order the goods or services, and have the bank who issued the credit card reverse the charge.

This particularly is a problem in the adult on-line industry. Frequently a user will purchase a trial or full membership in an adult site using a credit card, but, after having received a credit card bill including a charge for the membership, subsequently be motivated, for various reasons (such as domestic concerns), to contact the bank that issued the credit card and profess that he did not in fact engage the charge. Because of the fact that no product needs to be returned, the bank is often willing instantly to issue the credit; indeed, some credit card associations have adopted such a procedure as standard policy. The web site that vends electron-only products or services, such as access to adult web sites or downloadable music or computer programs, thus faces a very high charge-back rate. Moreover, since a large number of users who do engage a charge-back claim that they had never made the charge to begin with, the charge is noted as a fraudulent transaction, or a potentially fraudulent transaction.

Such notations have serious consequences for the merchant: when a sufficiently high percentage of the merchant's transactions (which can be as low as 1% or 1.5%), the merchant then is in jeopardy of being subjected to an increasing regime of fines and ultimately to termination of the merchant credit account. Currently such fines can range from $25 per charge-back to $150 per charge-back. Typical charge-back regimes increase their fines in $25 increments over a 4- to 6-month period. Thus, at the end of the fine regime, prior to termination of the merchant credit account, a merchant could be subject to $150 fines per allegedly fraudulent transaction. In addition, the merchant is subject to a processing fee, typically of $5 or more, and return or reversal of the charge itself.

Furthermore, the merchant will also frequently have paid for the traffic or referral that led to the reversed charge, and thus will suffer an additional loss in connection with that traffic or referral. For example, in a typical known affiliate program commonly used in the adult entertainment industry, an affiliate directs traffic to an adult site, which results in a registration of a new membership at a monthly rate of $29.95. The affiliate is then a referral fee, for example $40 (which typically represents the monetized advertising cost of an expected duration of membership exceeding 3 months.). But if there is a charge-back, the merchant loses not only the $29.95, but also the associated processing fees, the $40 referral fee, and up to $150 in charge-back fines. Thus a $29.95 charge which is the subject of a charge-back could result in a loss to the merchant of up to $225 or more.

In addition to the problem of intangibility, many web sites, in particular adult web sites, suffer from lack of product diversity. Many adult web sites only currently vend a unitary or singular type of product, namely adult materials. This is frequently due to advertiser reticence: even though people who frequent adult web sites purchase as broad a spectrum of consumer goods as any other consumer, adult web sites are precluded generally from advertising other types of things on their sites due to the reluctance of manufacturers of other consumer goods to be associated with adult web sites. Consequently, even though adult web sites generate more reliable traffic as an e-commerce sector than virtually any other sector, adult internet sites have had the problem of not being able to monetize and reprocess that traffic to sell other goods, because of the perceived negatives associated with adult web sites and explicit sexual depictions.

Moreover, the relative lack of non-explicit content exposes adult web sites to obscenity charges, to which they are particularly vulnerable in the absence of content of serious literary, artistic or scientific value as a defense to the charges.

### SUMMARY OF THE PREFERRED EMBODIMENTS

In accordance with one aspect of the present invention, there is provided a method of acquiring a membership in a destination site on a network. The method includes the steps of: accessing an affiliate site on a network, the affiliate site including a hyperlink to a destination site; accessing the destination site by activating the hyperlink; and acquiring a membership in the destination site and a tangible good associated with the membership in the destination site.

According to particular embodiments, the tangible good is a digital storage device, more specifically a CD-ROM. The CD-ROM includes, in more particular embodiments, at least one digital data file, for example an audio file, a video file, a photographic file, a graphic file or a text file.

In accordance with another aspect of the present invention, there is provided a method of confirming the acquisition of a membership in a site on a network. The method includes the steps of: providing a membership in a site on a network to a user requesting the membership; shipping a tangible good associated with the membership in the site to the user; and creating a record of the shipment of the tangible good to the user.

In accordance with a further aspect of the present invention, there is provided a method of providing a membership in a destination site on a network to a user. The method includes the steps of: receiving a request for membership in a destination site from a user, the user having been directed to the destination site from an affiliate site after having accessed the affiliate site; and providing to the user a membership in the destination site and a tangible good associated with the membership in the destination site.

According to particular embodiments, the tangible good is a digital storage device, such as a CD-ROM. The digital storage device includes, in specific embodiments, at least one digital data file, and in more specific embodiments, also includes a hyperlink to a third-party site on a network.

In accordance with still another aspect of the present invention, there is provided a method of conducting a transaction at a site on a network. The method includes the steps of: accessing an affiliate site on a network, the affiliate site including a hyperlink to a destination site; accessing the destination site by activating the hyperlink; acquiring a membership in the destination site and a digital storage device including a hyperlink to a third-party site on a network; accessing the third-party site by activating the hyperlink included in the digital storage device; and conducting a transaction at the third-party site.

According to specific embodiments, a valuable consideration is provided to the affiliate site after a user accesses the destination site. According to other specific embodiments, a valuable consideration is provided to destination site after a user accesses the third-party site.

A user acquiring the membership in the destination site and the digital storage device forwards the hyperlink to the third-party site to a second user in additional particular embodiments. The second user is then enabled to conduct a transaction at the third-party site. In more particular embodiments, a valuable consideration is provided to the user after the second user conducts the transaction.

In accordance with yet a further aspect of the present invention, there is provided a digital storage device associated with a destination site, the destination site having at least one affiliate site. The digital storage device includes a digital data file and a plurality of blocks of passwords, each of the plurality of blocks including a plurality of passwords, each of the plurality of blocks being associated with at least one affiliate site of the destination site.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a flowchart illustrating a first embodiment of a method according to the invention in which a user is directed from an affiliate site to a destination site and joins a periodic product program associated with the destination site, receiving as a premium a membership in the destination site,

FIG. 2 is a flowchart illustrating a second embodiment of a method according to the invention in which a user joins a periodic program in which the user receives a CD-ROM or other data storage medium, and uses the CD-ROM to access a third-party site and conduct a transaction at the third-party site, and

FIG. 3 is a flowchart illustrating a third embodiment of a method according to the invention in which a user, after accessing a third-party site on a CD-ROM acquired in a periodic program as described herein, forwards the third-party site to another user who in turn conducts a transaction at the third-party site.

### DETAILED DESCRIPTION OF THE PREFERRED EMBODIMENTS

The present invention is directed to a method, a system and an apparatus for multi-level marketing and fulfillment of goods on a network, for example a wide-area network such as the Internet. More specifically, the invention is directed to a method, a system and an apparatus for multi-level marketing employing a web site, such as an adult web site, that is primarily a locus for the vending of electron-based goods or services, such as membership to an adult site which entitles the member to a license to download photographs, videos and other adult audio and visual material.

In general, according to embodiments of the present invention, a user is directed to a web site, such as an adult web site, and instead of joining the adult web site directly, is afforded the option of joining a program in which a tangible good is shipped to the user at regularly specified intervals (for example monthly, i.e., as part of a “CD of the month club”). A premium is provided to the user who joins the program, wherein membership to the adult web site, or a license to download electron-based products such as photographic files, is tied to the continued membership in good standing in the program and to receipt of the tangible good(s), such as a CD.

The inventive method effectively reduces the incidence of fraudulent charge-backs, in that if a user wishes to charge back the membership in the program, the user must also return the associated tangible good. Consequently, a major basis on which users fraudulently request charge-backs, namely that the users have not actually joined the program with which the web site is associated, is removed. Once the tangible good has been returned, then a charge-back can legitimately be processed. However, the probability that the claim will be based on an assertion of a fraudulent charge will be significantly reduced or eliminated, since records will exist of the tangible good having been shipped to, and likely received and signed for by, the user.

In general, embodiments of the inventive method function in the following manner. A person or business entity known as an “affiliate” establishes a site (the “affiliate site”) on a network, more specifically a wide-area network such as the Internet or the World Wide Web. The affiliate site typically is a free site with a name that attracts the interest of network users, and thus generates a certain amount of traffic from search engines and other access methods. The affiliate site can include a greater or lesser amount of content, but also includes means for hyperlinking from the affiliate site to at least one site (the “destination site”).

The destination site preferably is a membership site, and preferably provides the affiliate site with some valuable consideration for a successful click-through (i.e., activation of the hyperlink to the destination site from the affiliate site by a user) or upon the user's acquisition of a membership offered by the destination site. In particular, the user is offered the choice of acquiring membership in a program wherein the user receives a tangible good, such as a CD-ROM or other item, on a periodic basis (for example, monthly, weekly, bimonthly, etc., including a single shipment of one item), together with a membership in the destination site, either without charge or at a reduced rate, the membership being effective so long as the user continues to receive and pay for the periodically provided tangible goods, or until the user requests cancellation of the membership(s). In the case in which a single tangible good is shipped to the user, the user's membership preferably continues until the user requests cancellation thereof.

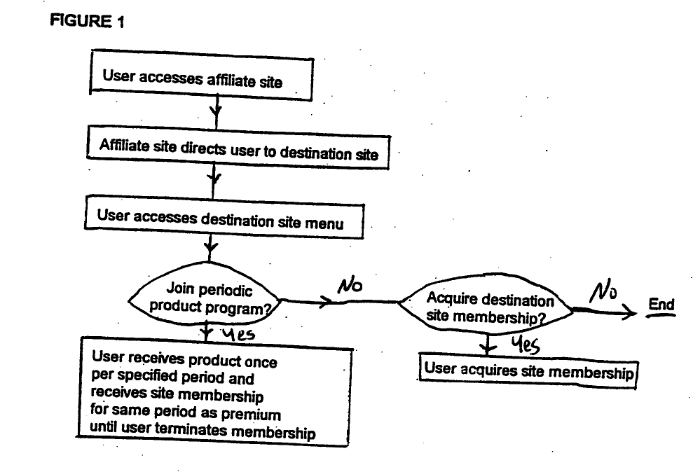

The foregoing can be understood more readily with reference to FIG. 1. In FIG. 1, a user first accesses an affiliate site. The affiliate site includes a hyperlink which the user can activate and which directs the user to a destination site (the affiliate site can include hyperlinks to more than one destination site in particular embodiments). The user then accesses a menu at the destination site, which can be an adult membership site or any other site offering memberships to users. The user is afforded the option of obtaining a membership with the destination site directly, or of joining a periodic product program, in which a tangible good is provided to the user on a periodic basis, together with a membership with the destination site (either without additional charge or at a reduced rate) as a premium, the membership being valid so long as the user continues to receive and pay for the tangible good for each succeeding period (or until the user cancels the membership).

In more particular embodiments, the affiliate site from which the user hyperlinked to the destination site is provided with an additional valuable consideration when the user either directly acquires a membership with the destination site or joins a periodic product program offered by the destination site. Thus for example, in addition to receiving from five to 50 cents for the click-through from the affiliate site to the destination site by the user, the affiliate site would receive an additional compensation, such as $40.00, when the user acquires a membership directly with the destination site or a membership in the periodic product program at a monthly rate, for example, of $29.95.

In order to stimulate user interest in obtaining memberships in the periodic product programs offered by the destination site, the tangible good offered preferably is a good having high user interest. Thus, for example, the tangible good offered to the user can be a CD-ROM that includes audio files containing musical selections, in particular compilations of performances by new artists; video files containing trailers for films, and more particularly films that are produced by independent film makers who are in great need of alternative distribution means; literary excerpt, for example exerpts of e-books, or entire e-books; photographic files containing images of artworks produced by new artists or artists seeking wider exposure; historical or scientific texts or materials for home study in various fields; and other artistic, educational or entertainment components.

Promotional materials describing at least a portion of the content of the products (such as CD-ROMs) to be periodically provided by the destination site can be included on the destination site. For example, third-party sites that are comfortable advertising their non-adult products on adult-oriented destination sites can post such promotional materials on the adult-oriented sites. Such posted materials further provide the adult-oriented site with serious literary, artistic and/or scientific value.

The tangible goods shipped to the user in connection with the destination site's periodic product program are not limited to CD-ROMs, but can be any tangible goods, such as books, magazines, artworks, posters, video or audio cassettes, audio CDs, DVDs, photographs, and any other types of tangible good.

The destination site, in particular embodiments, can generate additional revenue in connection with the periodic product program by charging a fee for each file provided on the CD-ROMs which users receive. Thus, each band, author, artist, filmmaker, etc. would pay a fee to the destination site in order for their material to be included on such CD-ROMs.

Provision of CD-ROMs including materials that can be displayed on a computer, however, affords further advantages to the destination site and the affiliate site(s). If the CD-ROM sent to the user includes one or more files including hyperlinks to additional web sites (“third-party sites”), the user can then hyperlink to the third-party site. At the third-party site, the user then can purchase additional goods and/or services, in particular embodiments non-adult-oriented goods and/or services. The proceeds generated by such sales at third-party sites can then be apportioned among the affiliate site, the destination site and the third-party site, providing each site with a benefit from its participation in the inventive method.

Accordingly, in particular embodiments, advertisers that are reticent to advertise on adult-oriented web sites can still benefit from the volume of traffic generated by such sites, because the users of the adult-oriented web sites receive the tangible goods, in particular CD-ROMs, from the adult-oriented web sites and are then directed to the third-party sites on which the reticent advertisers appear. Thus, the advertisers are not required to participate directly in the adult-oriented site.

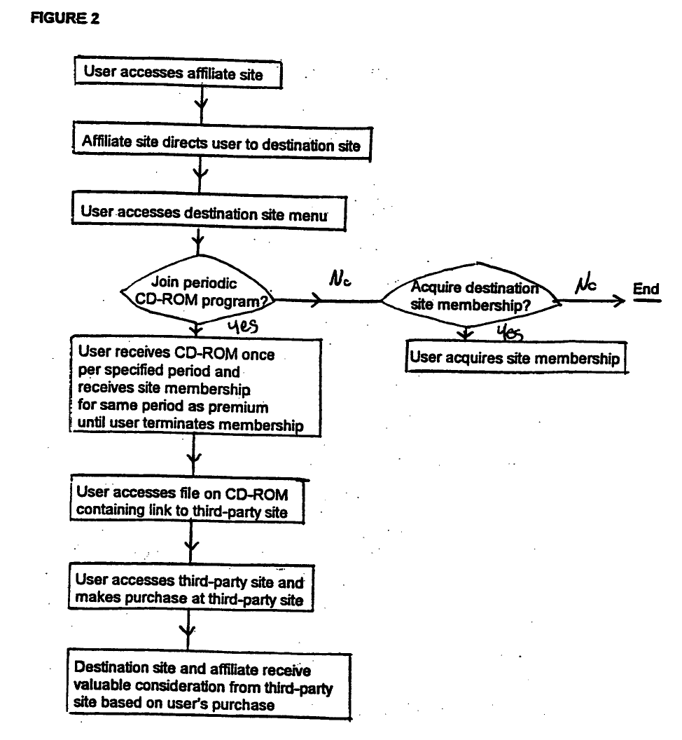

Referring now to FIG. 2, a user accesses an affiliate site and is directed to a destination site as in the previous illustrated embodiment. Once at the destination site, the user is afforded the option of obtaining a membership with the destination site directly, or of joining a periodic product program. More specifically, the user is afforded the option of periodically (including once only) receiving a CD-ROM, together with a membership with the destination site as a premium. Once the user receives a CD-ROM, the user can access the file(s) contained therein, including audio, video and/or text files as discussed above, and in particular can access one or more files containing hyperlinks to additional third-party sites. The user then accesses a third-party site and makes a purchase at the third-party site. Finally, the affiliate site and the destination site receive a valuable consideration (e.g., a share of the purchase price, a credit from the third-party site to be applied against future fees assessed by the destination site for inclusion in future CD-ROMs, etc.) based on the user's purchase at the third-party site.

In order to ensure that any transactions that the user conducts at the destination site and/or at one or more third-party sites result in the correct accreditation of valuable considerations to each site involved, the user preferably is associated with a password that identifies the user and the affiliate site that originally directed the user to the destination site. This association can be accomplished in various ways. According to specific embodiments involving the periodic shipment of CD-ROMs to the user, the user receives a password, such as a number or an alphanumeric combination, when the user obtains a membership in the destination site's periodic CD-ROM program, or together with the first CD-ROM (or alternatively receives a new password with one or more subsequent CD-ROMs). The user can input this password when the user accesses a third-party site using the CD-ROM in order to carry out a transaction at the third-party site. Input of the password enables identification of the user and the affiliate site, and allows the correct apportionment of valuable considerations to the third-party site, the destination site and the affiliate site.

To accomplish the desired association of a password with a user, according to one specific embodiment, the destination site that provides the CD-ROM includes on the CD-ROM a bank of passwords, which can be, for example, a set of 1024×1024 (i.e., 2²⁰) blocks of passwords, each block of which can contain a selected number of different passwords, for example 4096 passwords. Each block is associated with an affiliate (which can be the same affiliate or a plurality of affiliates). Thus in the foregoing example, up to about one million different affiliates can be accommodated, with each affiliate being assigned a block of 4096 different passwords. The user further receives a disc-enabling password (DEP) from the destination site, which the destination site has associated with a particular password out of the block of passwords assigned to the affiliate site that originally directed the user to the destination site.

In order to use the CD-ROM to hyperlink to, and conduct a transaction at, a third-party site associated with one or more files on the CD-ROM, the user first provides the DEP to the destination site (for example, directly via an authorization hyperlink contained in the third-party site's file on the CD-ROM, or indirectly via a hidden hyperlink that is activated by the user at the third-party site). Once the destination site receives the user's DEP, the destination site compares the DEP with a listing of DEP's and associated affiliate passwords to determine which affiliate site's block of passwords includes the password associated with the user's DEP. Having made the required pairing, the destination site then queries the user's computer to scan the block of passwords on the user's CD-ROM that is associated with the appropriate affiliate site, in order to determine if the user's DEP is paired with a valid affiliate site password. If the password paired with the user's DEP is found on the user's CD-ROM in the block of passwords associated with the affiliate site, then the user is authorized to complete the transaction at the third-party site.

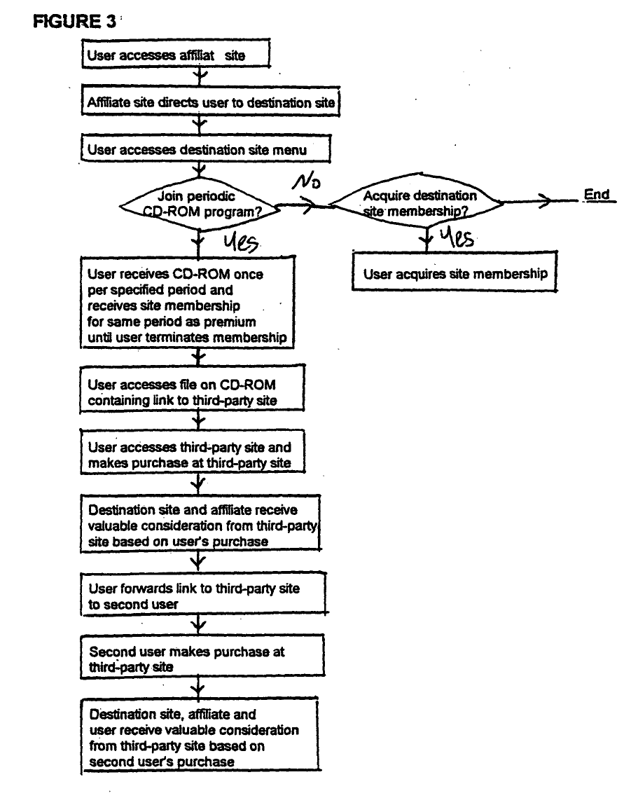

Additional marketing opportunities can be realized according to further specific embodiments of the inventive method that permit a user to forward a hyperlink to a third-party site to a second user, as illustrated in FIG. 3. After accessing a third-party site by use of a CD-ROM as described above, the user participating in the destination site's periodic product program is afforded the option of forwarding a hyperlink to the third party's site to a second user via e-mail or other desired means. Preferably, the second user also receives a password that identifies the (first) user as the source of the referral, and further identifies the affiliate site and the destination site. When the second user wishes to conduct a transaction at the third-party site, the second user enters the password that accompanied the hyperlink referral. Upon completion of the transaction, valuable considerations are apportioned among the affiliate site, the destination site and the third-party site, as with the preceding embodiments, using the password to facilitate this apportionment. Additionally, the user making the referral is provided with a valuable consideration (for example, a credit applicable to the next periodic product program charge, a gift certificate, etc.), again using the password to facilitate the apportionment.

What is claimed is:

1. A method of acquiring a membership in a destination site on a network, the method comprising the steps of:
a) accessing an affiliate site on a network, the affiliate site including a hyperlink to a destination site,
b) accessing the destination site by activating the hyperlink, and
c) acquiring
i) a membership in the destination site and
ii) a tangible good associated with the membership in the destination site.

2. The method of claim 1 wherein the tangible good is a digital storage device.

3. The method of claim 2 wherein the digital storage device is a CD-ROM.

4. The method of claim 3 wherein the CD-ROM includes at least one digital data file.

5. The method of claim 4 wherein the digital data file is selected from the group consisting of an audio file, a video file, a photographic file, a graphic file and a text file.

6. The method of claim 1 wherein in step b) a tangible good is provided to the user periodically.

7. The method of claim 1 wherein in step b) the membership in the destination site is renewed periodically.

8. The method of claim 1 wherein a user acquiring the membership in the destination site is associated with a password that identifies the user and the affiliate site.

9. A method of confirming the acquisition of a membership in a site on a network, the method comprising the steps of:
a) providing a membership in a site on a network to a user requesting the membership,
b) shipping a tangible good associated with the membership in the site to the user, and
c) creating a record of the shipment of the tangible good to the user.

10. A method of providing a membership in a destination site on a network to a user, the method comprising the steps of:
a) receiving a request for membership in a destination site from a user, the user having been directed to the destination site from an affiliate site after having accessed the affiliate site, and
b) providing to the user
i) a membership in the destination site and
ii) a tangible good associated with the membership in the destination site.

11. The method of claim 10 wherein the tangible good is a digital storage device.

12. The method of claim 11 wherein the digital storage device is a CD-ROM.

13. The method of claim 12 wherein the CD-ROM includes at least one digital data file.

14. The method of claim 13 wherein the digital data file is selected from the group consisting of an audio file, a video file, a photographic file, a graphic file and a text file.

15. The method of claim 12 wherein the CD-ROM includes a hyperlink to a third-party site or a network.

16. The method of claim 10 wherein in step b) a tangible good is provided to the user periodically.

17. The method of claim 10 wherein in step b) the membership in the destination site is renewed periodically.

18. The method of claim 10 further comprising the step of providing a valuable consideration to the affiliate site after step b).

19. A method of conducting a transaction at a site on a network, the method comprising the steps of:
a) accessing an affiliate site on a network, the affiliate site including a hyperlink to a destination site,
b) accessing the destination site by activating the hyperlink,
c) acquiring
i) a membership in the destination site and
ii) a digital storage device including a hyperlink to a third-party site on a network,
d) accessing the third-party site by activating the hyperlink included in the digital storage device, and
e) conducting a transaction at the third-party site.

20. The method of claim 19 wherein the digital storage device is a CD-ROM.

21. The method of claim 19 further comprising the step of providing a valuable consideration to the affiliate site after step b).

22. The method of claim 19 further comprising the step of providing a valuable consideration to the destination site after step e).

23. The method of claim 19 wherein a user acquiring the membership in the destination site is associated with a password that identifies the user and the affiliate site.

24. The method of claim 23 wherein the password further identifies the third-party site.

25. The method of claim 19 wherein a user acquiring the membership in the destination site and the digital storage device forwards the hyperlink to the third-party site to a second user.

26. The method of claim 25 wherein the second user conducts a transaction at the third-party site.

27. The method of claim 26 further comprising the step of providing a valuable consideration to the user after the second user conducts the transaction.

28. A digital storage device associated with a destination site, the destination site having at least one affiliate site, the digital storage device comprising:
i) a digital data file and
ii) a plurality of blocks of passwords, each of the plurality of blocks comprising a plurality of passwords, each of the plurality of blocks being associated with at least one affiliate site of the destination site.
